(19) United States
(12) Patent Application Publication
(10) Pub. No.: US 2026/0020535 A1
(43) Pub. Date: Jan. 22, 2026

(54) CLEANABLE MOBILE DRIP IRRIGATION SYSTEM

(71) Applicant: Tyler Rendleman, Big Rapids, MI (US)

(72) Inventor: Tyler Rendleman, Big Rapids, MI (US)

(21) Appl. No.: 18/773,691

(22) Filed: Jul. 16, 2024

(51) Int. Cl. A01G 25/02

(52) U.S. Cl. CPC A01G 25/023

(57) ABSTRACT

A drip irrigation unit includes conduits for delivering the irrigation water in small quantities directly to the plants being irrigated. The water is pressurized and dripped onto the soil adjacent to the plant. It can, however, be delivered in a slow trickle to the soil. The device includes a system that can be utilized to clean the device when it becomes clogged and ceases to drip.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

A drip irrigation unit includes conduits for delivering the irrigation water in small quantities directly to the plants being irrigated. The water is pressurized and dripped onto the soil adjacent to the plant. It can, however, be delivered in a slow trickle to the soil.

Flow rates for these types of irrigators are typically in the neighborhood of one gallon per hour of water at a pressure of about twenty-five pounds per square inch.

Because of the small opening in the irrigator for releasing the water, the irrigation units become easily plugged and prevent the even flow of water.

The instant invention provides a means by which the irrigation unit and be unplugged and otherwise cleaned so that an even, continual supply of water is maintained.

One such known prior art irrigation unit can be found in U.S. Pat. No. 3,753,527, that issued to Galbraith on Aug. 21, 1973, which deals with a drip irrigation system that will allow particles to pass through the exit orifices.

U.S. Patent Publication 2003/0001029 that published on Jan. 2, 2003, to Neyestani deals with a self-discharging drip irrigation device.

U.S. Patent 7,048, 010 that issued on May 23, 2006, to Rolan, et al, deals with a drip irrigation system that is low pressure using feeder pipes and drip pipes.

Prior art advertised units consist of Bloom brothers GGWR06 inch hydro Halo Water; 3″ Matrix Circulator; Hydro flow Rain ring drip emitter; Matrix Circulator 3″ drip irrigation ring, and Halo Water Ring Hydroponics Soil Drip Irrigator.

### BRIEF SUMMARY OF THE INVENTION

Thus, what is disclosed and claimed herein is a cleanable mobile drip irrigation unit. The unit comprises a semi-circular hollow open top ring having an interrupted ring opening, a plurality of small spaced-apart openings in a surface of said semi-circular hollow open top ring, and an inlet port for pressurized water.

### BRIEF DESCRIPTION OF THE SEVERAL VIEWS OF THE DRAWING(S)

FIG. 1 is a full top view of a device of this invention showing the channel and water openings.

FIG. 2 is a full side view of a device of this invention showing a round tube configuration.

FIG. 3 is a full bottom view of the device of FIG. 1.

### DETAILED DESCRIPTION OF THE INVENTION AND DRAWINGS

What is disclosed and claimed herein is a cleanable mobile drip irrigation unit.

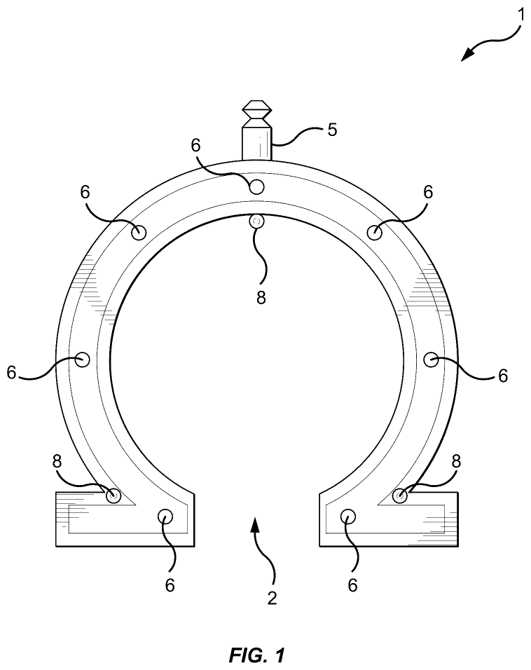

With regard to FIG. 1, there is shown a full top view of a semi-circular open top hollow ring 1 having an interrupted ring opening 2. By “interrupted ring opening” 2, it is meant that the ring is not fully circular but has a gap existing between two terminal ends as shown in FIGS. 1, 2, and 3.

The ring is an open channel in which water is carried to the openings 6.

Further shown is an input nozzle 5 for inputting water into the ring 1 by the attachment of a pressurized hose (the hose is not part of the invention). Water is supplied to the device such that the water is under pressure, like for example, from a water hose or the like.

There is a plurality of small spaced-apart openings 6 in a channel of the semi-circular open top hollow ring 1 as is shown in FIGS. 1 and 3. These opening have a diameter of about 1 to 6 mm, just enough opening that the water contained inside the open top ring 1 can drip or drizzle from the device to the ground. These openings 6 can be in a bottom surface of the channel 1 or the side wall 7 of the open top ring 1, or a combination of such openings. These openings are designated “drip emitters” in the art.

Also shown in FIG. 3 are spiked support legs 8. Typically, there are four or five such legs, but usually three is both efficient and economical. The legs are adjustable in order to level the device so that water flows evenly.

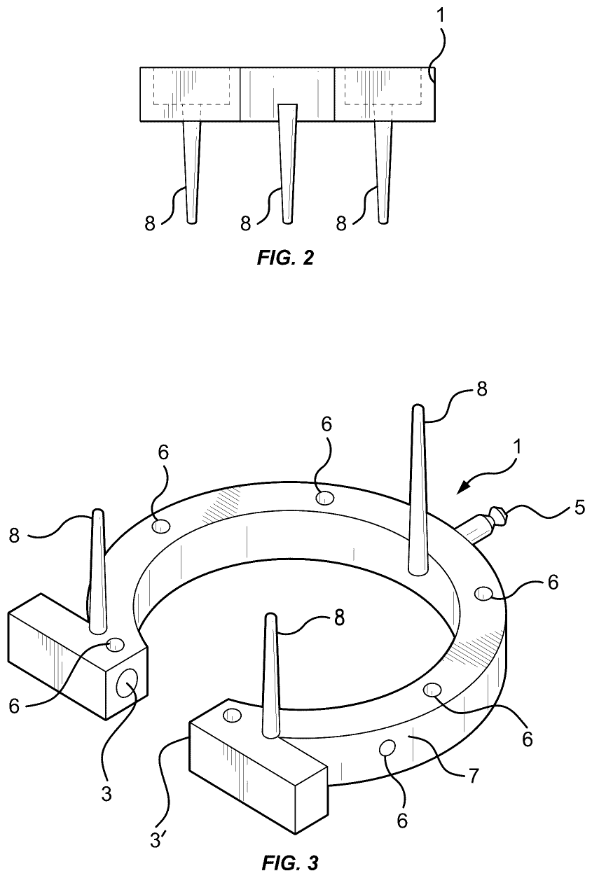

Turning now to FIG. 2 which is a full side view of the device of FIG. 1 and FIG. 3 and note that the support legs are shown as 8. The advantage of the configuration of the instant device is that the openings can be cleaned from the top of the device without having to gain entry into an interior of the device.

The diameter of the ring is 4 inches to 8 inches.

What is claimed is:

1. A cleanable mobile drip irrigation unit, said unit comprising:
a semi-circular hollow open top ring having an interrupted ring opening;
a plurality of small spaced-apart openings in a surface of said semi-circular open top hollow ring, and
an inlet port for pressurized water.

2. A mobile irrigation system as claimed in claim 1 wherein said small spaced-apart openings in said surface have a diameter of 1 mm to 6 mm.

3. A mobile irrigation system as claimed in claim 1 wherein, in addition, said mobile irrigation system has at least two support legs.

4. A mobile irrigation system as claimed in claim 3 wherein, in addition, said support legs are spiked.

5. A mobile irrigation system as claimed in claim 1 wherein the diameter of the semi-circular open top ring is 4 inches to 8 inches.

6. A mobile irrigation system as claimed in claim 1 wherein said small spaced-apart openings are in a bottom surface of said semi-circular open top hollow ring.

7. A mobile irrigation system as claimed in claim 1 wherein said small spaced-apart openings are in a side wall of said semi-circular open top hollow ring.
